(19) United States
(12) Patent Application Publication
(10) Pub. No.: US 2007/0000522 A1
(43) Pub. Date: Jan. 4, 2007

(54) Container handling machine

(75) Inventor: Karl Griesbeck, Regensburg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KRONES AG, Neutraubling (DE)

(21) Appl. No.: 10/567,532

(22) PCT Filed: Jun. 7, 2004
(86) PCT No.: PCT/EP04/07351

§ 371 Date: Jun. 21, 2006

(30) Foreign Application Priority Data
Aug. 7, 2003 (DE) 203 12 210.0

(51) Int. Cl. B08B 9/093

(52) U.S. Cl. 134/22.18

(57) ABSTRACT

A container treatment machine having a frame, a table top inclined to the horizontal being attached to the topside so that at least one collecting opening for fluids, container fragments or similar foreign bodies is formed in the table top, and the areas of the table top connected to the collecting opening are inclined with a downward slope to the collecting opening.

### CROSS-REFERENCE TO RELATED APPLICATIONS

The present application claims the benefit of priority of German Patent Application No. 203 12 210.0 filed Aug. 7, 2003. The entire text of the priority application is incorporated herein by reference in its entirety.

### FIELD OF THE DISCLOSURE

The invention relates to a container treatment machine.

### BACKGROUND OF THE DISCLOSURE

Such a container treatment machine in which the table plate is inclined with an outward descent in the manner of a roof is already known. Due to this inclination, runoff of fluids, fragments of broken containers or the like is facilitated, while cleaning and keeping the container treatment machine sterile, if necessary, are significantly facilitated. However, the fragments, etc. falling down from the outside edge of the table top remain lying around the frame, where they can interfere with the operating personnel and must be collected and removed in a time-consuming operation.

### SUMMARY OF THE DISCLOSURE

In a container treatment machine of the type defined in the introduction, the object of the present disclosure is to permit targeted removal of the liquid residues, container fragments or the like which drop down from the table top.

With an inventive container treatment machine, the liquid residues, container fragments and other foreign bodies can be discharged in a targeted manner through the collecting opening toward the underside of the table top and/or the frame, where they remain lying without interfering with the operators and can be removed occasionally. The outside of the frame is largely undisturbed and there remains enough room in the interior of the frame for drive units or the like. The inclined areas of the table top can be formed in the simplest way by a few smooth plates, sheets or the like which are easy to keep clean.

It is especially advantageous if a drop chute for the liquid residues, container fragments or similar foreign bodies is connected to the collecting opening toward the bottom. The foreign bodies entering the collecting opening may then be diverted downward merely through the force of gravity, e.g., into a collecting container or toward the floor beneath the frame.

### BRIEF DESCRIPTION OF THE DISCLOSURE

An exemplary embodiment of the present disclosure is described below with reference to the figures, in which:

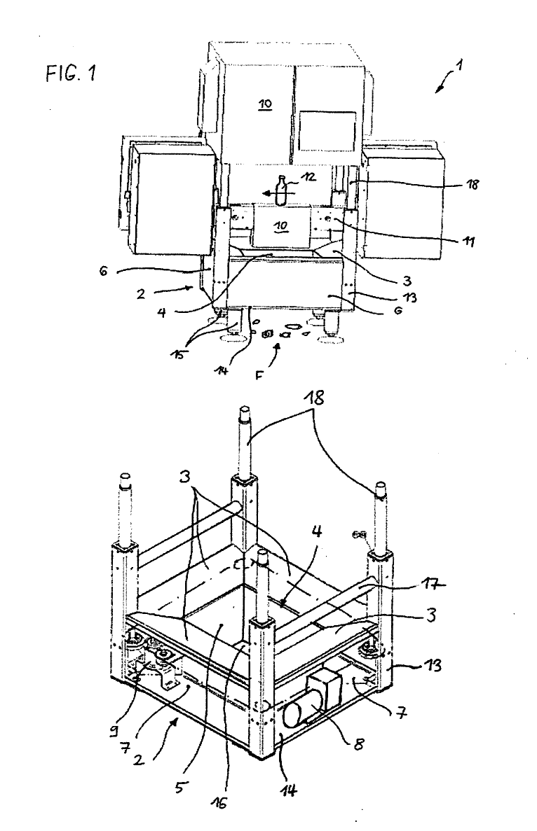

FIG. 1 shows a perspective view of a bottle inspection machine;

FIG. 2 shows a perspective view of the frame of the bottle inspection machine according to FIG. 1 with the side walls removed.

### DETAILED DESCRIPTION OF THE DISCLOSURE

The container treatment machine 1 designed as a bottle inspection machine according to FIGS. 1 and 2 is equipped so that empty, freshly cleaned, returnable bottle made of glass, hereinafter referred to simply as bottles 12, may be inspected for contaminants. The machine has a cube-shaped frame 2 with four corner pillars 13, a horizontal bottom plate 14 and a table top 3 arranged at a distance above the former. For adjustable feet 15 with which the frame 2 is erected on the floor of the building in horizontal alignment are attached to the bottom plate 14. The aforementioned parts of the frame 2 are rigidly joined together. Plate-shaped side walls 6 are detachably inserted between the four corner pillars 13; these side walls are essentially aligned with the corner pillars 13 and cover the area between the bottom plate 14 and the table top 3 toward the outside. Centrally in the essentially rectangular table top 3 there is a rectangular collecting opening 4 for liquid residues, fragments, pieces of containers or the like, hereinafter referred to as foreign bodies F. The areas of the table top 3 adjacent to the four sides of the collecting opening 4 are arranged at a downward inclination, falling toward the collecting opening 4, preferably in an angle range from 20° to 30° to the horizontal. This causes the foreign bodies F to automatically slide down the table top 3 toward the collecting opening 4. The table top 3 consists of four bent and beveled sheet metal parts which are welded to one another and to the corner pillars 13.

Four vertical metal plates are attached to the four inside edges of the table top 3 which define the collecting opening 4, forming a rectangular drop chute 5 for the foreign bodies F. The drop chute 5 runs vertically and extends to the bottom plate 14 which is provided with a corresponding outlet opening 16 that is aligned with the collecting opening 4, as seen from above. The foreign bodies F sliding down from the table top 3 are thus collected by the collecting opening 4 and then diverted in a targeted manner through the drop chute 5 and its outlet opening 6 to the floor area beneath the frame 2, where they cannot interfere with the operator and can be removed at the side between the feet 15 without any problem. Because of the good accessibility and the smooth design, it is also easy to keep the table top 3 and the drop chute 5 clean and, if necessary, sterile.

Horizontal bars 17 are mounted between two neighboring corner pillars 13 on the narrow sides of the frame 2. A horizontal linear conveyor, labeled as 11 on the whole and consisting of two conveyor belts with a pair of belts (not shown) forming a bridge over the gap formed by these two conveyor belts is also mounted on this bar. The linear conveyor 11 runs centrally over the collecting opening 4 in the area of the table top 3 so that the foreign bodies F falling down can be received optimally by the collecting opening 4. The lighting device 10 of an inspection device for the bottles 12 on the whole is arranged in the gap between the two conveyor belts; the top part of the inspection device with the cameras and the electronics is supported by four threaded spindles 18, mounted so they can rotate in the corner pillars 13, so that the top part is adjustable in height.

A ring-shaped hollow space 7 which is essentially closed on all sides is formed between the bottom plate 14, the table top 3, the drop chute 5 and the four side walls 6 of the frame 2. A control element 9 in the form of a geared motor having a chain connection with the four spindles 18 is arranged in this hollow space so that the spindles 18 can be rotated in synchronization for the purpose of adjusting the height of the inspection device 10. Furthermore, a geared motor 8 is arranged in the hollow space 7, driving the belts of the linear conveyor 11 arranged on both sides of the linear conveyance path of the bottles 12 by means of chain connections (not shown). These elements are well protected on the one hand and yet on the other hand are readily accessible by removing the side walls 6, if necessary.

1. Container treatment machine (1) comprising a frame (2), a table top (3) inclined to the horizontal being attached to the top side of the frame, at least one collecting opening (4) for liquids, fragments of containers or similar foreign bodies (F) formed in the table top (3), and the areas of the table top (3) connected to the collecting opening (4) being inclined with a falling slope to the collecting opening (4).

2. Container treatment machine according to claim 1, wherein a drop chute (5) for the foreign bodies (F) is connected to the collecting opening (4) toward the lower end.

3. Container treatment machine according to claim 1 wherein the collecting opening (4) has a rectangular base shape and is positioned centrally in the table top (3) which also has a rectangular base shape.

4. Container treatment machine according to claim 1, wherein a hollow space (7) to receive one of drive elements (8) and control elements (9) is formed between the drop chute (5) and the outside walls (6) of the frame (2).

5. Container treatment machine according to claim 4, wherein the hollow space (7) is ring-shaped.

6. Container treatment machine according to claim 1, wherein a treatment device (10) for the containers is arranged above the collecting opening (4).

7. Container treatment machine according to claim 1, wherein a linear conveyor (11) for the containers is arranged above the collecting opening (4).

8. Container treatment machine according to claim 1, wherein the container treatment machine is designed as an inspection machine.
